(19) United States
(12) Patent Application Publication
(10) Pub. No.: US 2007/0038671 A1
(43) Pub. Date: Feb. 15, 2007

(54) Method, apparatus, and computer program product providing image controlled playlist generation

(75) Inventors: Jukka A. Holm, Tampere (FI); Jyri Rinnemaa, Tampere (FI); Antti Eronen, Tampere (FI); Juha Arrasvuori, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/200,791

(22) Filed: Aug. 9, 2005

(51) Int. Cl. G06F 17/00

(52) U.S. Cl. 707/104.1

(57) ABSTRACT

A program of machine-readable instructions, tangibly embodied on an information bearing medium and executable by a digital data processor, to perform actions directed toward generating a playlist for a mobile device, the actions including performing an analysis of an image, and selecting at least one audio file in accordance with a result of the analysis.

### TECHNICAL FIELD

This invention relates generally to user interfaces and, more specifically, to devices capable of providing media content to a user.

### BACKGROUND

It is known in the realm of portable or mobile devices, such as personal digital assistants (PDAs), mobile phones, and the like to create playlists to aid in the playing of desired audio files. Typically, such audio files are in the form of songs. As used herein, a “playlist” refers to a list of one or more audio files, usually songs, that are designated to be played. In addition to songs, playlists may alternatively refer to classical concertos and the like wherein different genres and tempi are embodied, such as renaissance, baroque, classic, romantic, modern classic, or classification into major and minor keys and beats. Examples of audio file types that may form a playlist include CD audio files, MP3 audio files, and WMA audio files. Playlists are typically defined manually, or are downloaded at a time which is removed from the time when the actual listening of the songs forming the playlists is accomplished. As a result, playlists that are constructed to convey a predefined mood, for example happy or sad songs, may not fit the mood of a listener at the moment when the playlist is invoked or otherwise executed.

Various methodologies have been employed to more closely match the mood of a user of a mobile device to the operation of the mobile device. For example, as described in patent application WO 2005/031627 A1, there is described a methodology whereby an image is analyzed so as to extract one or more attributes of the image. These attributes are then utilized to generate game content on platforms that enable the playing of games. In other contexts, such as in U.S. Pat. No. 6,230,047B1, the heartbeat/pulse of a user is determined and utilized to play songs which have an underlying beat similar to the pulse rate of the user.

### SUMMARY OF THE PREFERRED EMBODIMENTS

In accordance with an exemplary embodiment of the invention, a program of machine-readable instructions is provided, tangibly embodied on an information bearing medium and executable by a digital data processor, to perform actions directed toward generating a playlist on an electronic device. The actions include performing an analysis of an image, and selecting at least one audio file in accordance with a result of the analysis.

In accordance with another exemplary embodiment of the invention, a method to operate an electronic device includes performing an analysis of an image, and playing at least one audio file that is selected in accordance with a result of the analysis.

In accordance with another exemplary embodiment of the invention, an electronic device includes a user interface for acquiring an image, a memory for storing the image, and a processor coupled to the memory for accessing the stored image, extracting at least one attribute of the stored image, and generating a playlist comprising at least one audio file from the at least one attribute.

### BRIEF DESCRIPTION OF THE DRAWINGS

The foregoing and other aspects of these teachings are made more evident in the following Detailed Description, when read in conjunction with the attached Drawing Figures, wherein:

FIG. 1. is a logic flow diagram of an exemplary method of the invention.

FIG. 2 is a block diagram of an exemplary embodiment of a mobile device that is suitable for practicing this invention.

FIGS. 3a-3c are illustrations of mappings between images and audio files according to an exemplary embodiment of the invention.

FIGS. 4a-4b are illustrations of images of differing complexity according to an exemplary embodiment of the invention.

FIGS. 5a-5b are illustrations of images formed of line drawings according to an exemplary embodiment of the invention.

### DETAILED DESCRIPTION

In an exemplary embodiment of the invention, there is provided a mobile device capable of capturing an image, performing image analysis of the image to extract at least one attribute of the image, and using the attributes so extracted to generate a playlist. In an exemplary embodiment of the invention, the image is captured by a camera coupled to the mobile device. In another exemplary embodiment, the image is a line drawing entered by a user through a user interface coupled to the mobile device whereby the image is analyzed to extract attributes, such as line thickness and stroke speed, which are subsequently used to generate a playlist.

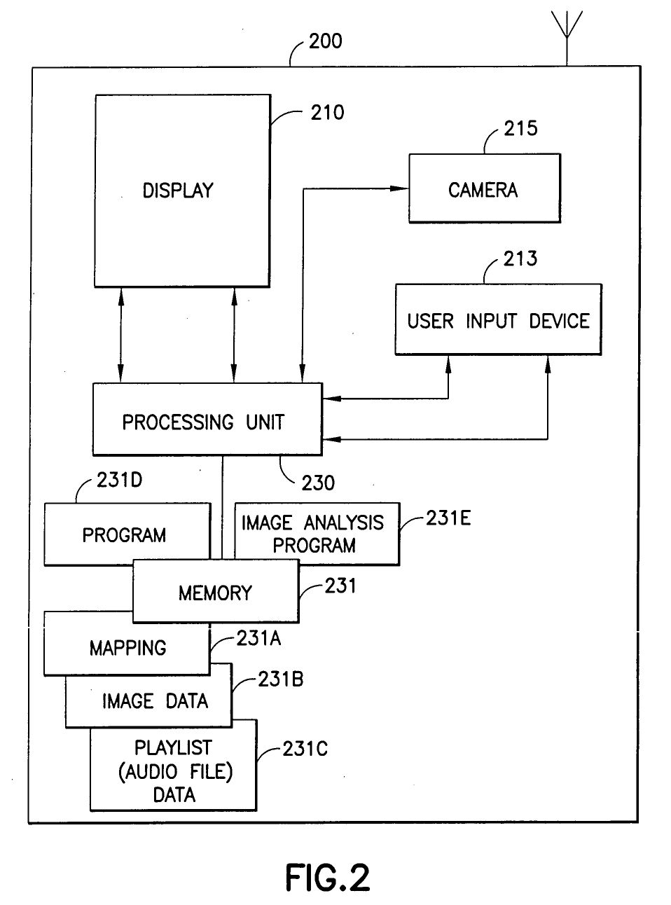

With reference to FIG. 2, there is illustrated a block diagram of an exemplary mobile device 200 for practicing the invention. In an exemplary embodiment, mobile device 200 is a mobile phone though it may be, but is not limited to, a PDA, a portable computer, or a gaming device. Mobile device 200 is formed of a user input device 213 coupled to a processor, or processing unit, 230. Processor 230 and user input device 213 are preferably in bi-directional communication with one another. Processor 230 is configured to execute machine readable code 231D, 231E stored in a memory 231 so as to perform the actions described herein including, but not limited to, performing image analysis and generating a playlist. User input device 213 may comprise one or more of a keyboard, touch pad, or other device operable to allow a user of the mobile device 200 to enter data for receipt by the processor 230. Processor 230 is able to store data in memory 231 and retrieve data from memory 231. Examples of data which may be stored in the memory 231 include image files 231B, and audio and playlist files 231C.

Processing unit 230 is further coupled to display 210. In the event that processing unit 230 is bidirectionally coupled to display 210, display 210 can likewise function as a user input device 213 such as when display 210 is a touch screen. In addition, display 210 can operate in concert with user input device 213 to function as a singular user input device 213. For example, a joystick device may be incorporated into user input device 213. In such a configuration, the joystick can be manipulated to move a cursor or other visual indicia around the display 210 to create an image, such as a line drawing. The image may be processed in real time, such as to record the speed at which the cursor is moved, or may be stored in memory 231 as an image and utilized by the processor 230 for the extraction of image attributes.

As noted, a camera 215 can be coupled to, or otherwise integrated with, mobile device 200. In such a configuration, the user of the mobile device 200 can point the camera 215 to a scene having at least one attribute which is in general accordance with the attribute(s) of a playlist desired to be generated. The user can proceed to utilize the camera 215 to record an image which may be stored in memory 231 as image data 231B.

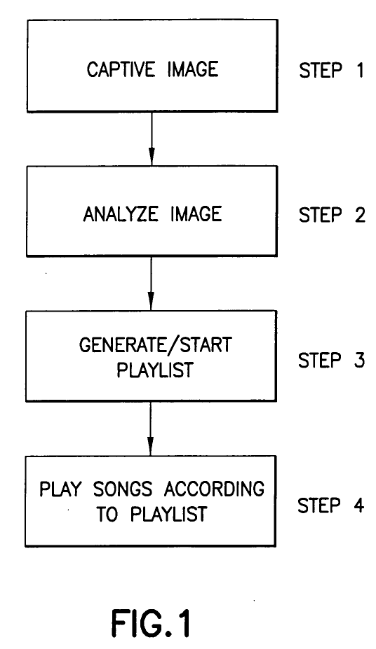

With reference to FIG. 1, there is illustrated the methodology of an exemplary embodiment of the invention. At step 1, an image is captured or otherwise acquired, such as from the memory 231 coupled to the mobile device 200. At step 2, the image data 231B is analyzed so as to extract at least one attribute of the image as is described more fully below. At step 3, the extracted attribute(s) are utilized to generate a playlist. Lastly, at step 4, the playlist is utilized to play the songs or other audio files forming the playlist. In an alternative exemplary embodiment of the invention, an existing playlist may be selected based upon the playlist's correspondence to the extracted attributes.

At step 2, an image stored in memory 231 as image data 231B is retrieved and processed, typically by processor 230, to extract one or more attributes of the image. The image may have been captured by the camera 215, or it may have originated external to the mobile device 200, as when downloaded from the internet. The image may also be one generated at the mobile device 200 using the user input device 213. Examples of attributes that may be extracted include, but are not limited to, the average color of the image, as well as visual features of the image such as overall image complexity derived from, for example, the frequency and density of lines and edges appearing in the image. Additional image attributes that may be extracted include, but are not limited to, average brightness, contrast, and the color and brightness of single pixels.

With particular reference to the extraction of the attribute of an average color of an image, a mapping is performed between the extracted attribute and the available audio files, for example those stored in memory 231, so as to generate a playlist as illustrated in step 3 of FIG. 1. In an exemplary embodiment, a default mapping is provided that maps a color attribute of an image to a genre of music. For example, bright images composed of light colors may cause the selection of songs for a playlist that have slower tempos and are more ambient than songs which would be selected in the case of a darker picture. An example of one such mapping is as follows:

| Image Attribute | | Song Genre |
|---|---|---|
| Black, dark images | −> | Aggressive, fast tempo |
| | | music |
| White, yellow, light, bright | −> | Slow, relaxed, |
| | | classical, etc. music |
| Blue | −> | Blues music |
| Purple | −> | Funk, soul music |
| Pink | −> | Glam rock |

In an exemplary embodiment, the mapping 231A is stored in memory 231 and is accessed by the processor 230 when generating a playlist. While described as a default mapping, the user may edit or otherwise modify the mapping 231A. In an exemplary embodiment, such modifications are performed via the user interface device 213 operating in concert with the display 210. By modifying the mapping 231A, a user is able to customize the manner in which different types of images give rise to playlists which reflect the individual users emotional reaction to the images.

In addition to modifying the actual mapping of attributes to music genres, the user can additionally instruct the processor operations with respect to the results of the image analysis. For example, after performing image analysis, the processor 230 may display on display 210 the results of the analysis by, for example, printing the results of the analysis. For example, after analyzing a light blue image of the sky, the processor 230 may display the designations “light” and “blue” to the user. The user may interact with the processor 230, such as through the use of the user input device 213, to indicate that the user considers the image to be “dark” and “blue”. In this manner, the processor 230 can learn the subjective designations and preferences of a user and store such preferences as modifications to the mapping in memory 231 for retrieval when generating a playlist as described more fully below.

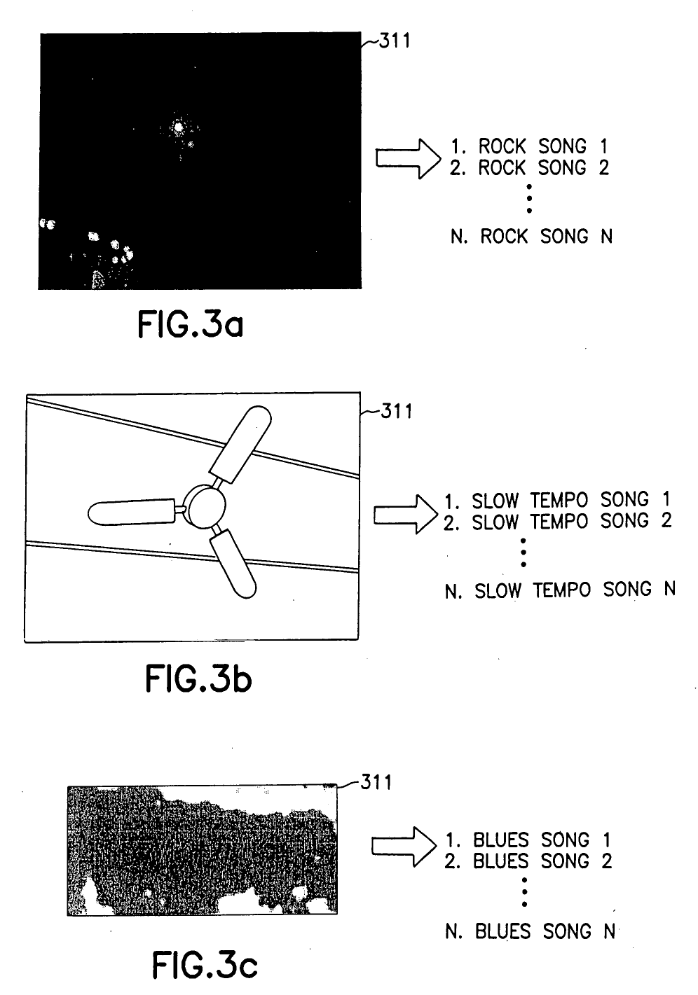

With reference to FIGS. 3a-3c, there is illustrated in pictorial fashion a mapping of exemplary images 311 to exemplary song genres. In FIG. 3a, a dark image 311 of a nightscape is mapped to a plurality of rock songs. In FIG. 3b, a light image 311 of a ceiling fan is mapped to a plurality of slow tempo songs. Lastly, in FIG. 3c, a predominantly blue image 311 of clouds, is mapped to a plurality of blues songs.

As noted above, once the attribute of image color is extracted, a playlist 231C can be constructed using the stored mapping 231A. One exemplary method by which such a mapping can be performed is as follows. Many music file formats contain header fields for meta-data. One such field may be utilized to record the genre, or any other attribute, of the song contained within the audio file. Such designations may be encoded in and distributed with the audio file. In an alternative exemplary embodiment, the user may insert a desired genre or other attribute into the header of an audio file. Regardless of the method by which the genre or other attribute of an individual audio file is attached to the audio file, once so designated, it is possible to use the header data of the audio file to perform the mapping from image file to song genre as described above.

Once the image attribute, or attributes, have been extracted from an image, the mapping of the attribute or attributes to individual songs is performed to generate a playlist. In an exemplary embodiment, processor 230 utilizes the mapping 231A to select one or more songs from memory 231 so as to generate a playlist 231C which may likewise be stored in memory 231. Playlist generation may require, or make use of, additional information provided from the user, such as the number of songs to be included in the playlist, when generating a playlist. In the instance that there are more songs matching the mapping of an image than the user has requested in the generated playlist, songs matching the mapping 231A may be selected randomly, may be granted priority based upon at least one additional attribute of the image, or may be selected based upon a rank ordering derived from a statistical fit between the attributes of an audio file and the mapping criteria.

In an alternative embodiment, visual features of an image other than color can be extracted for use in mapping an image to songs so as to create a playlist. For example, image complexity, such as that derived from the density of image constructs such as lines and edges, can be extracted from the image. A resulting exemplary mapping might map high complexity images to songs having high rhythmical complexity and density, melodic complexity and density, and the like. Conversely, a low complexity image may be mapped to more relaxed or easy to listen to songs. As above, header information indicating the rhythmic complexity of an audio file may be distributed with the audio file, may be added by the user, or may be computed and automatically entered by the processor 230.

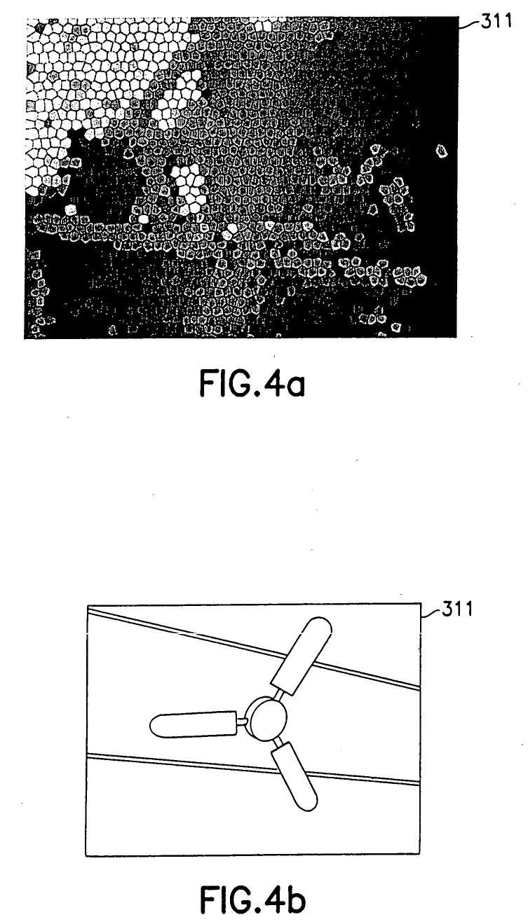

With reference to FIGS. 4a-4b, there is illustrated in pictorial fashion exemplary images of differing complexity. FIG. 4a shows a mosaic containing many edges and lines and forming a relatively high complexity image. In contrast, FIG. 4b shows a relatively low complexity image of a ceiling fan.

In an alternative exemplary embodiment, the image upon which analysis is performed may be formed of a line drawing entered by the user. As noted above, the line drawing may be entered via user input device 213. Such an image may be formed, for example, by manipulating a joystick or using a stylus in concert with the display 210. Regardless of the method by which the line drawing is entered, attributes can be extracted from the image as it is being created or after creation.

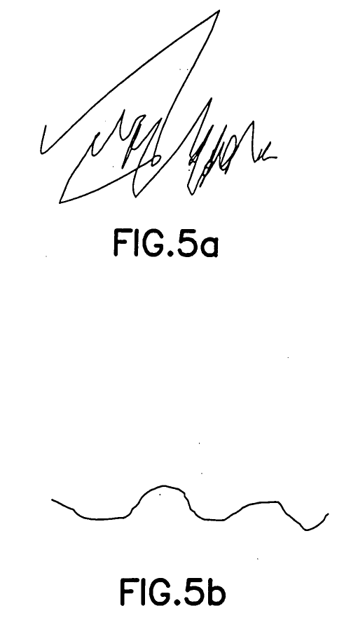

With reference to FIGS. 5a-5b, there are illustrated two exemplary images formed of line drawings. When a user enters such an image, the processor 230 can record attributes, or characteristics, of the line drawing such as the speed at which each line is drawn, overall characteristics for the drawing (e.g. sharp corners, smooth curves, etc.), and, in some instances, stylus pressure. In an alternative exemplary embodiment of the invention, a preferred audio file tempo may be measured, such as by processor 230, as when a user taps upon a user input device 213 capable of sensing pressure, such as a touch screen display, rocker, or other entry key. As before, a mapping is created between the extracted attributes and a genre, or type, of song corresponding to the extracted attribute. For example, with respect to the image of FIG. 5a, the jagged and irregular nature of the quick line strokes could be mapped to fast tempo, or atonal, songs. Conversely, the smooth, curving nature of the image of FIG. 5b could be mapped to easy listening music or to songs with a slow tempo.

As with the mapping between image characteristics, such as average color or image complexity, and the genre or type of song, a user can similarly manipulate or otherwise edit the mapping to suit individual tastes. For example, utilizing a user input device 213, a user can interact with the processor 230 to provide sample line drawings and to indicate preferred genres or types of songs to be mapped to each sample line drawing. It is understood that all such interaction between the user and the processor 230 may be facilitated by the visual interface provided by the display 210.

In an exemplary embodiment of the invention, the mobile device 200 is a cell phone within which is stored one or more audio files in memory 231, and the mobile device 200 includes an image capture device, such as the camera 215. Such a configuration provides a user the ability to record an image, for example, at approximately the same time as a playlist is generated and executed. When a playlist is executed, the songs which are selected to form the playlist as described above, commence to play. It will be appreciated that an identical image can give rise to different playlists formed of different songs depending on the individual mobile devices 200 upon which the image analysis and playlist generation are performed. Such differences may arise when the default mapping between image characteristics and song genres varies from one mobile device 200 to the next. In addition, the individual audio files stored in the memory 231 of each mobile device 200 will likely differ and therefore give rise to different selections of songs when the playlist is generated.

In an alternative exemplary embodiment, the playlist may be generated as described above on an electronic device, for example a personal computer, other than the mobile device 200 on which the audio files are to be played. In such a configuration, the image used to generate the playlist may be resident upon the electronic device, may be received from a mobile device 200, or may be accessed from an external source, such as the internet. Once generated, the playlist can be transmitted from the electronic device, acting as a server, to the mobile device 200. Such a transmission may occur using a wireless or hardwire connection, or may, alternatively, involve the use of physical media such a data card. In addition to the transmission of the playlist, audio files referenced in the playlist, but not resident in the mobile device 200, can be similarly transferred from the electronic device to the mobile device 200.

It is understood that the various exemplary embodiments described herein may be implemented in hardware or special purpose circuits, software, logic or any combination thereof. For example, some aspects may be implemented in hardware, while other aspects may be implemented in firmware or software which may be executed by a controller, microprocessor, processor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in hardware, software, firmware, special purpose circuits or logic, general purpose hardware or controller or other computing device, or some combination thereof.

Alternative exemplary embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys™, Inc. of Mountain View, Calif. and Cadence™ Design, of San Jose, Calif. automatically route conductors and locate components on a semiconductor chip using well established rules of design as well as huge libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Although described in the context of particular embodiments, it will be apparent to those skilled in the art that a number of modifications and various changes to these teachings may occur. Thus, while the invention has been particularly shown and described with respect to one or more exemplary embodiments thereof, it will be understood by those skilled in the art that certain modifications or changes may be made therein without departing from the scope and spirit of the invention as set forth above, or from the scope of the ensuing claims.

What is claimed is:

1. A program of machine-readable instructions, tangibly embodied on an information bearing medium and executable by a digital data processor, to perform actions directed toward generating a playlist on an electronic device, the actions comprising:
performing an analysis of an image; and
selecting at least one audio file in accordance with a result of the analysis.

2. The program of claim 1, further comprising playing the at least one selected audio file.

3. The program of claim 1 comprising:
extracting at least one attribute of the image; and
generating a playlist comprising at least one audio file from said at least one attribute.

4. The program of claim 3 comprising selecting said playlist based on said at least one attribute.

5. The program of claim 1 wherein said electronic device comprises a user interface device for acquiring said image.

6. The program of claim 1 wherein said electronic device comprises a camera for acquiring the image.

7. The program of claim 1 comprising storing said image in a memory.

8. The program of claim 1 wherein performing an analysis comprises extracting at least one attribute of the image, where the at least one attribute comprises an average color of the image.

9. The program of claim 1 wherein performing an analysis comprises extracting at least one attribute of the image, where the at least one attribute comprises at least one feature of the image.

10. The program of claim 9 wherein said at least one feature comprises at least one line attribute.

11. The program of claim 9 wherein said at least one feature comprises at least one edge attribute.

12. The program of claim 3 wherein said at least one attribute comprises image complexity.

13. The program of claim 3 wherein generating comprises mapping said at least one attribute to at least one audio file type.

14. The program of claim 13 comprising editing said mapping via a user input device.

15. The program of claim 1 wherein said image comprises a line drawing.

16. The program of claim 13 wherein an attribute encoded in a header of said at least one audio file is used to map said at least one audio file to said at least one attribute.

17. The program of claim 1 wherein said electronic device comprises a mobile phone.

18. The program of claim 1 wherein said audio file comprises a song.

19. A method to operate an electronic device comprising:
performing an analysis of an image; and
playing at least one audio file that is selected in accordance with a result of the analysis.

20. The method of claim 19 further comprising:
extracting at least one attribute of said image; and
generating a playlist comprising at least one audio file from said at least one attribute.

21. An electronic device comprising:
a memory for storing image data;
means for performing image analysis of said image data to extract at least one attribute; and
means for generating a playlist comprising at least one audio file from said at least one attribute.

22. The electronic device of claim 21 wherein said electronic device comprises a mobile device.

23. The electronic device of claim 21 wherein said electronic device comprises a mobile phone.

24. The electronic device of claim 21 wherein said at least one audio file comprises a song.

25. The electronic device of claim 21 where said at least one attribute is indicative of at least image complexity.

26. The electronic device of claim 21 where said at least one attribute is indicative of at least image color.

27. The electronic device of claim 21 wherein said image comprises a line drawing.

28. The electronic device of claim 21 wherein the image data is captured by the electronic device.

29. The electronic device of claim 21 wherein the image data is generated with a user input of the electronic device.

30. The electronic device of claim 21 wherein the image data is retrieved from a database.

31. The electronic device of claim 21 wherein the image data is downloaded from a source of image data external to the electronic device.
